(19) United States
(12) Patent Application Publication
(10) Pub. No.: US 2006/0063531 A1
(43) Pub. Date: Mar. 23, 2006

(54) System and method for providing a BCMCS service in a wireless communication system

(75) Inventors: Jung-Soo Jung, Seoul (KR); Beom-Sik Bae, Suwon-si (KR); Dae-Gyun Kim, Seongnam-si (KR); Yu-Chul Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/228,342

(22) Filed: Sep. 19, 2005

(30) Foreign Application Priority Data
Sep. 20, 2004 (KR) 2004-75262

(51) Int. Cl. H04Q 7/20

(52) U.S. Cl. 455/442; 455/435.1; 455/137

(57) ABSTRACT

A system and method for providing broadcast traffic according to the location of an access terminal (AT) are provided. The AT determines whether a registration request for soft combining from an access network transceiver system (ANTS) belonging to a candidate set is present when an overhead message is received from the ANTS or the candidate set is changed. The AT is configured to add the ANTS to a registration list for the soft combining when the request is present. The AT sends to the ANTS a broadcast registration message at a transmission time point after setting the transmission time point to send the broadcast registration message including a broadcast/multicast service (BCMCS) service provision request for the soft combining. A network provides the AT with the overhead message including information about neighbor ANTSs and information about ANTSs for which the soft combining on broadcast traffic is enabled.

### CROSS REFERENCE TO RELATED APPLICATIONS

This application claims the benefit under 35 U.S.C. §119(a) of Korean Patent Application No. 10-2004-0075262, entitled “System and Method for Providing a BCMCS Service in a Wireless Communication System” filed in the Korean Intellectual Property Office on Sep. 20, 2004, the entire disclosure of which is incorporated herein by reference.

### BACKGROUND OF THE INVENTION

1. Field of the Invention

The present invention relates generally to a system and method for providing a broadcast/multicast service (BCMCS) service in a wireless communication system. More particularly, the present invention relates to a system and method for providing broadcast traffic according to location of an access terminal (AT).

2. Description of the Related Art

A typical wireless communication system is a mobile communication system. Such a mobile communication system has been developed to provide voice service without limiting the location of users. With the development of technology, the mobile communication system has further developed into a system that is capable of providing various types of services. One of the technologies currently being standardized by Third-Generation Partnership Project 2 (3GPP2) is a broadcast service for mobile communication systems.

In 3GPP2, many methods have been proposed for providing broadcast service in a high rate packet data service (HRPD) system called “a code division multiple access 2000 1× (CDMA2000 1×)” or “1× evolution data only (1× EVDO)”. One currently proposed broadcast service will be briefly described with reference to FIG. 1.

In a proposed method for supporting broadcast service in the HRPD system, multiple cells (or sectors) are designated as one broadcast group. When an access terminal (AT) desiring to receive a broadcast is present in the broadcast group, associated broadcast traffic is sent throughout the broadcast group. The AT desiring to receive the broadcast performs a soft combining operation on a signal of associated broadcast traffic, thereby increasing reception performance. However, when an AT desiring to receive a broadcast is absent in the broadcast group, the transmission of associated broadcast traffic is stopped.

According to the above-described method, several cells (or sectors) form one broadcast group to provide the broadcast service. Broadcast traffic transmission is determined in a group unit. That is, if at least one AT is receiving a broadcast in a certain cell (or sector) within the group, associated broadcast traffic is sent throughout the group. Otherwise, broadcast traffic is not sent to any AT within the group. In this system, an AT can perform a soft combining or soft handoff operation using only signals sent from access network transceiver systems (ANTSs) within a group including an area in which the AT is located.

FIG. 1 illustrates a relation between ANTSs and ATs in a broadcast service group according to a conventional system. Referring to FIG. 1, the relation between ANTSs and ATs in a broadcast service group will be described with reference to FIG. 1.

It is assumed for purposes of the current explanation that Broadcast Group-1 100 includes six ANTSs 101, 102, 103, 104, 105 and 106, and Broadcast Group-2 110 includes six ANTSs 111, 112, 113, 114, 115 and 116. Moreover, it is assumed that an AT 130 included in Broadcast Group-1 100 and ATs 140 and 150 included in Broadcast Group-2 110 receive a broadcast service. In this case, the AT 130 included in Broadcast Group-1 100 receives a radio signal through three ANTSs 104, 105 and 106. One AT 140 included in Broadcast Group-2 110 can receive a broadcast service from two ANTSs 111 and 112, and another AT 150 included in Broadcast Group-2 110 can receive a broadcast service from other three ANTSs 114, 115 and 116. In this case, the ATs 130, 140 and 150 can soft combine data of broadcast services received from the ANTSs.

The ATs 130, 140 and 150 can soft combine only signals received from the ANTSs included in each broadcast group. This is because the ANTSs of each broadcast group corresponding to the unit providing the broadcast service provide the same service, and no broadcast service is provided from a different broadcast group to an associated AT.

A case where a broadcast/multicast service (BCMCS) is provided using the above-described method has the following problems.

First, broadcast traffic may be unnecessarily sent from the ANTSs to an AT incapable of receiving the broadcast traffic when the broadcast traffic transmission is ON/OFF on the basis of a BCMCS service group. For example, the ANTSs 101, 102 and 103 of Broadcast Group-1 100 are ANTSs from which the AT 130 does not receive a BCMCS service. In the BCMCS service group, all ANTSs from which the AT 130 does not receive a BCMCS service may unnecessarily send broadcast traffic. Accordingly, there is a problem in that radio resources are unnecessarily wasted and unnecessary traffic increases in a radio access network (RAN).

Second, reception performance may be degraded in an AT located at a boundary between broadcast groups. For example, when the AT 130 of Broadcast Group-1 100 is located adjacent to Broadcast Group 2, it must soft combine weak signals received from the ANTSs 104, 105 and 106 of Broadcast Group 1 and must use the soft combined signals. The AT 130 cannot receive a signal from the ANTS 112 corresponding to the specific ANTS of Broadcast Group-2 110 even when the signal of the ANTS 112 is better. When the BCMCS service is provided according to the above-described method, the quality of BCMCS service may be degraded. This is because the AT 130 cannot receive an associated BCMCS service from any ANTS of Broadcast Group-2 110.

Accordingly, a need exists for a system and method for minimizing waste of radio resources in a wireless communication system for providing a broadcast/multicast service (BCMCS) service.

### SUMMARY OF THE INVENTION

It is, therefore, an object of the present invention to substantially solve the above and other problems, and provide a system and method that can prevent radio resources from being wasted in a wireless communication system for providing a broadcast/multicast service (BCMCS) service.

It is another object of the present invention to provide a system and method that can prevent network resources from being wasted in a wireless communication system for providing a broadcast/multicast service (BCMCS) service.

It is another object of the present invention to provide a system and method that can provide a high quality of broadcast/multicast service (BCMCS) to an access terminal (AT) in a wireless communication system for providing the BCMCS service.

It is another object of the present invention to provide a system and method for requesting a broadcast/multicast service (BCMCS) in an access terminal (AT) of a wireless communication system for providing the BCMCS service.

It is yet another object of the present invention to provide a system and method that can receive a broadcast/multicast service (BCMCS) from associated access network transceiver systems (ANTSs) by giving notification of information about the ANTSs for which a soft combining operation can be performed in an access terminal (AT) of a wireless communication system for providing the BCMCS service.

The above and other objects of the present invention can be achieved by a system for providing a broadcast/multicast service (BCMCS), comprising an access terminal (AT) for determining if a registration request for soft combining from an access network transceiver system (ANTS) belonging to a candidate set is present when an overhead message is received from the ANTS or the candidate set is changed, adding the ANTS to a registration list for the soft combining when the request is present, and sending to the ANTS a broadcast registration message at a transmission time point of the broadcast registration message after setting the transmission time point to send the broadcast registration message including a BCMCS service provision request for the soft combining. The system further comprises a network for providing the AT with the overhead message including information about neighbor ANTSs and information about ANTSs for which the soft combining on broadcast traffic is enabled.

The above and other objects of the present invention can also be achieved by a method for sending a broadcast/multicast service (BCMCS) provision request from an access terminal (AT) to an access network transceiver system (ANTS) in a communication system configured by ANTSs and ATs, the AT receiving a BCMCS service from the ANTS. The method comprises the steps of setting a transmission time point of a broadcast registration message using a broadcast registration timer, and sending the broadcast registration message to the ANTS when the transmission time point of the broadcast registration message is reached.

Preferably, the transmission time point may be a time point when the broadcast registration timer has reached a periodic registration time point, a dynamic registration time point, or a soft combining registration time point.

Preferably, an initial value of the broadcast registration timer may be set to an arbitrary value.

The above and other objects of the present invention can also be achieved by a method for providing a broadcast/multicast service (BCMCS) from an access network transceiver system (ANTS) to an access terminal (AT) in a mobile communication system configured by ANTSs and ATs, comprising the steps of starting a broadcast deactivation timer for an associated BCMCS service when a registration request for soft combining is set, determining when the started broadcast deactivation timer has timed out, deactivating transmission for the BCMCS service when the broadcast deactivation timer has timed out, and stopping an operation of the broadcast deactivation timer. The method further comprises the steps of determining if a broadcast registration message for the BCMCS service has been received when the broadcast deactivation timer has not timed out, maintaining the BCMCS service when the broadcast registration message has been received for the BCMCS service, and stopping the operation of the broadcast deactivation timer.

### BRIEF DESCRIPTION OF THE DRAWINGS

The above and other objects and advantages of the present invention will be more clearly understood from the following detailed description of exemplary embodiments thereof when read in conjunction with the accompanying drawings, in which:

FIG. 1 illustrates conventional access network transceiver systems (ANTSs) and access terminals (ATs) in a broadcast service group;

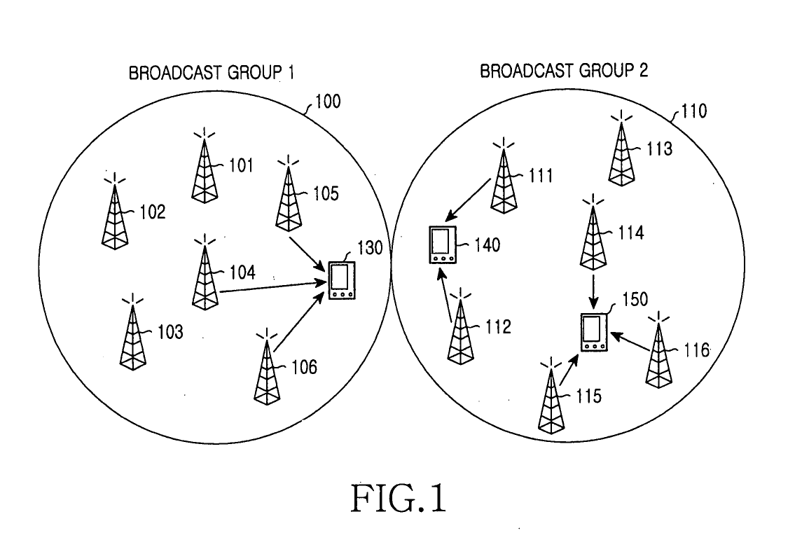

FIG. 2 illustrates a network structure of a high rate packet data service (HRPD) system capable of providing a broadcast/multicast service (BCMCS) service;

FIG. 3 illustrates ATs and ANTSs for providing a BCMCS service according to location of the ATs in accordance with an embodiment of the present invention;

FIG. 4 illustrates the format of an overhead message for a broadcast in accordance with an embodiment of the present invention;

FIG. 5 is a flowchart illustrating a control operation for transmitting the broadcast overhead message while a network for providing a BCMCS service is operating in accordance with an embodiment of the present invention;

FIG. 6 is a flowchart illustrating a broadcast deactivation operation in a neighbor ANTS in accordance with an embodiment of the present invention;

FIG. 7 is a flowchart illustrating a broadcast registration operation for soft combining in an AT in accordance with an embodiment of the present invention; and

FIG. 8 is a flowchart illustrating an operation for generating and transmitting a broadcast registration message in accordance with an embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will now be described in detail herein below with reference to the accompanying drawings. In the following description, detailed descriptions of functions and configurations incorporated herein that are well known to those skilled in the art are omitted for clarity and conciseness.

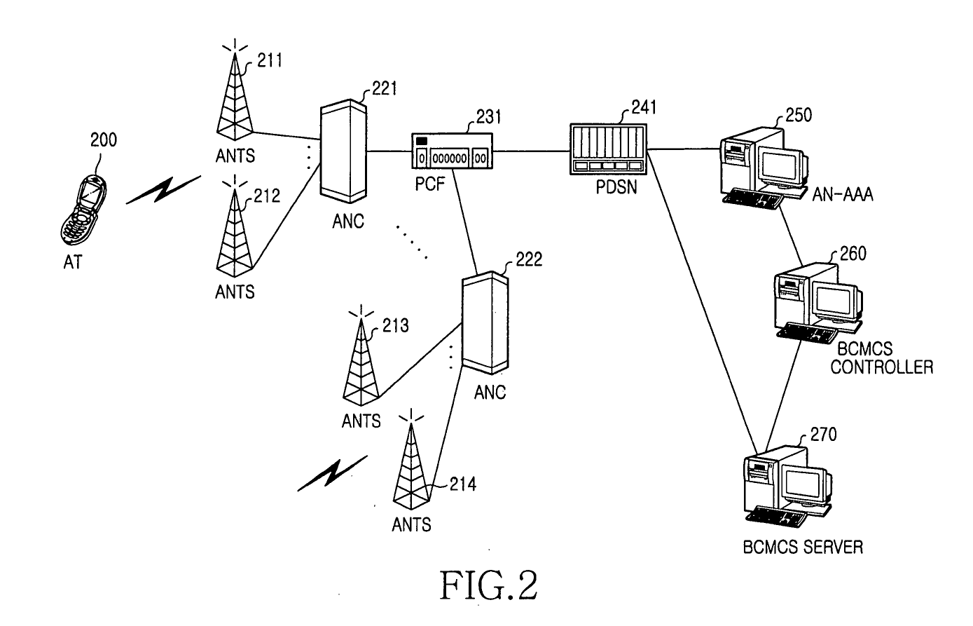

FIG. 2 illustrates a network structure of a high rate packet data service (HRPD) system capable of providing a broadcast/multicast service (BCMCS) service. The structure and operation of the HRPD system for providing the BCMCS service in accordance with embodiments of the present invention will be described with reference to FIG. 2.

First, the components of the HRPD system comprise access network transceiver systems (ANTSs) 211, 212, 213 and 214, access network controllers (ANCs) 221 and 222, a packet control function (PCF) entity 231, a packet data service node (PDSN) 241, and an access network-authentication, accounting and authorization (AN-AAA) entity 250 for authentication in the HRPD system. The exemplary HRPD system is connected to a BCMCS controller 260 and a BCMCS server 270 for providing the BCMCS service.

The ANTSs 211, 212, 213 and 214 can provide an access terminal (AT) 200 with the BCMCS service or various other data services of the HRPD system through a radio channel, and are connected to the ANCs 221 and 222. The ANCs 221 and 222 control the ANTSs 211, 212, 213 and 214 connected to a low level, and are connected to the PCF entity 231. The PCF entity 231 is connected to the PDSN 241 and can perform a processing operation for the BCMCS service and the data services through the PDSN 241. The PDSN 241 is connected to the AN-AAA entity 250 and can authenticate the AT 200 in the HRPD system. The PDSN 241 provides the BCMCS service through the BCMCS server 270. The PDSN 241 can be coupled to the BCMCS controller 260 through the BCMCS server 270 or can be directly connected to the BCMCS controller 260. Here, the BCMCS server 270 and the BCMCS controller 260 are described only as a controller and server for providing the BCMCS service, but are not limited thereto.

FIG. 2 illustrates an exemplary structure of a HRPD system. A 1× evolution data & voice (1× EV-DV) system that is capable of providing a service similar to that of the HRPD system can have substantially the same structure as the HRPD system. In the case of a code division multiple access 2000 1× (CDMA2000 1×) system, the ANTSs 211, 212, 213 and 214 are replaced with base transceiver systems (BTSs) that are well known to those skilled in the art, for transmitting and receiving a radio signal, and the ANCs 221 and 222 are replaced with base station controllers (BSCs) that are well known to those skilled in the art, for controlling the BTSs. When a packet data service or a BCMCS service according to embodiments of the present invention is provided, the BSCs transmit and receive packet data through the PCF entity 231. When voice service is provided, the BSCs can be connected to a mobile switching center (MSC) or mobile switching center emulation (MSCe) and a media gateway (MGW) (not illustrated in FIG. 2). Therefore, it should be noted that the following is applicable to all systems except where the HRPD and CDMA2000 1× systems are specially distinguished in the following description.

A group for the BCMCS service as illustrated in FIG. 2 can be formed on the basis of the ANC 221 or 222, or the PCF entity 231. When Broadcast Group-1 100 and Broadcast Group-2 110 as described above are formed in an ANC unit, the ANTSs 211 and 212 connected to the low level of the first ANC 221 can form one broadcast group for providing one BCMCS service, and the ANTSs 213 and 214 connected to the low level of the second ANC 222 can form another broadcast group. However, when the broadcast group is formed on the basis of the PCF entity 231, one broadcast group is formed by the first ANC 221, the ANTSs 211 and 212 connected to the low level of the first ANC 221, the second ANC 222, and the ANTSs 213 and 214 connected to the low level of the second ANC 222.

In embodiments of the present invention, the above-described network operation can be performed in the ANC or PCF entity, and activation or deactivation of the BCMCS service can be achieved in an ANTS unit or in a unit of a sector or cell of the ANTS. An operation for controlling the activation or deactivation of the BCMCS service may be performed in the ANC, but preferably the service activation and deactivation is achieved in the cell or sector unit in the ANTS.

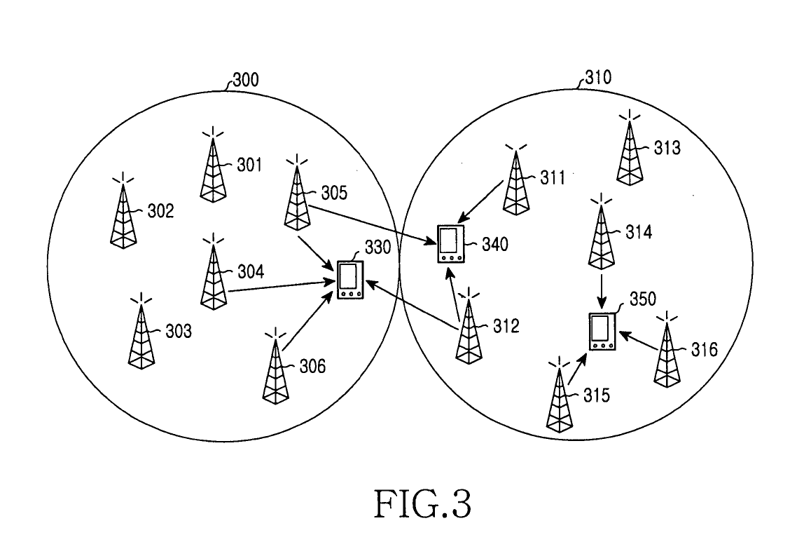

FIG. 3 illustrates a process for providing a BCMCS service from ANTSs according to location of an AT that is not in a group unit for the BCMCS service, in accordance with embodiments of the present invention.

Referring to FIG. 3, the first and second groups 300 and 310 are illustrated which are formed by grouping a unit of an ANC or PCF entity. In the following description, it is assumed for purposes of the current explanation that the group is formed by grouping the ANC unit.

When any one of the ANTSs of the first and second groups 300 and 310 provides a BCMCS service in the conventional system, other ANTSs that are incapable of providing BCMCS service data must also provide the same BCMCS service to an AT receiving the BCMCS service. When only ANTSs 304, 305 and 306 of ANTSs 301, 302, 303, 304, 305 and 306 included in the first group 300 can communicate with an AT 330 receiving the BCMCS service, embodiments of the present invention enable the ANTSs 304, 305 and 306 to send BCMCS service data to the AT 330. The other ANTSs 301, 302 and 303 do not provide the BCMCS service.

When the AT 330 can receive the BCMCS service from a specific ANTS of ANTSs 311, 312, 313, 314, 315 and 316 of the second group 310 corresponding to another group, it can receive the BCMCS service regardless of a group covered by an ANC. For example, the AT 330 can receive the BCMCS service from the ANTSs 304, 305 and 306 of the first group 100, and also from the ANTS 312 of the second group 110. This is equally applicable to other ATs 340 and 350. The AT 350 located in an area covered by only one ANC can receive the BCMCS service from the ANTSs 314, 315 and 316.

An exemplary system operation for a BCMCS service request of an AT while preventing network resources from being wasted when the BCMCS service is provided in accordance with embodiments of the present invention will now be described.

Network Operation

First, the network operation will be described. The network operation may be performed in the PCF entity 231 or in the ANCs 221 and 222 as described above in relation to FIG. 2. The network operation may be subdivided into the operations of the PCF entity 231 and the ANC 221.

A case where the network operation is subdivided into four operations will be described. The four operations comprise a first operation for activating broadcast traffic transmission, a second operation for deactivating broadcast traffic transmission, a third operation for providing an overhead message for a BCMCS service from an ANTS of the network, and a fourth operation for control in the network. The four operations will now be described in greater detail.

Operation 1—Activation of Broadcast Traffic Transmission

When receiving a BCMCS registration message from an AT, an ANTS activates associated broadcast traffic transmission in a cell or sector included in the message. As described above, BCMCS service activation can be controlled in the ANC or PCF entity. The ANC or PCF entity can determine whether to provide a BCMCS service from a neighbor cell or sector on the basis of a pilot sent along with the BCMCS registration message sent from the AT through the ANTS. For example, when the pilot received from the AT is included in a candidate set of the AT and broadcast traffic of an associated neighbor cell or sector can be soft combined with broadcast traffic sent from a cell in which the AT is located, the network performs broadcast traffic transmission in the cell.

This is described in greater detail with reference to FIG. 3. As illustrated in FIG. 3, the AT 330 receives a BCMCS service from the neighbor ANTSs 304, 305, 306 and 312 and improves the quality of BCMCS service by performing the soft combining operation associated with the received BCMCS service. For this, the network activates broadcast traffic transmission to provide the BCMCS service if the network can provide the BCMCS service on the basis of information reported by the AT 330 although an AT receiving the BCMCS service is absent within an area covered by the ANTS 304. Of course, the network does not perform an additional activation process for the ANTS 304 when the ANTS 304 is currently transmitting associated broadcast traffic.

Operation 2—Deactivation of Broadcast Traffic Transmission

On the basis of the above-described activation method, the ANTS activates the broadcast traffic transmission and provides the BCMCS service. When the ATs do not send BCMCS registration messages during a predetermined time period, for example, the maximum transmission period, the BCMCS service is stopped if the following conditions are satisfied.

First, any BCMCS registration for a specific cell or ANTS preferably must not exist during a predetermined time period, for example, the minimum period for deactivating broadcast traffic. Second, a pilot of a specific cell or ANTS reported from an AT located in an area covered by a cell or ANTS neighboring a specific cell or ANTS preferably must not be included in a candidate set of an associated AT while the BCMCS registration for the specific cell or ANTS does not exist. In this case, any AT does not receive broadcast traffic from the specific cell or ANTS and therefore does not perform soft combining.

Even though the above-described conditions are satisfied, the network sends broadcast traffic during a predetermined time period, for example, the minimum period for sending the broadcast traffic. In relation to the third condition, the network determines if the BCMCS registration is performed during the minimum period. To determine the third condition, embodiments of the present invention send to all the specific cell and neighbor cells, a broadcast overhead message into which information about the specific cell or ANTS and a BCMCS service request field for soft combining have been inserted. Fields of the overhead message used and sent by the ANTS will be described in greater detail below. The broadcast traffic from the specific cell or ANTS is stopped when a BCMCS registration message is not received during the predetermined time or when a pilot signal of the specific cell or ANTS reported from an AT receiving broadcast traffic of the neighbor cell is not included in a candidate set of an associated AT. The third condition is optional, and therefore, the network may be configured such that the network stops broadcast traffic transmission using only the first and second conditions.

### Operation 3—Overhead Transmission from ANTS

Currently proposed broadcast overheads to be provided from a system for providing a BCMCS service will now be described in greater detail. A BCMCS registration period and a broadcast overhead message will be briefly described.

As described above, the BCMCS registration message is sent from an AT in a preset period. This period may comprise two types of periods. The broadcast overhead message comprises indicators indicating a request for sending the BCMCS registration message at a time point of an associated period. The indicators comprise two indicators as described in greater detail below.

(1) Registration Required Indicator for Paging

When an indicator field is set to “1”, an AT sends to an ANTS a BCMCS registration message in each registration period for paging previously received from the ANTS.

(2) Registration Required Indicator for a Dynamic Broadcast

When an indicator field is set to “1”, an AT sends to an ANTS a BCMCS registration message in each registration period for a dynamic broadcast previously received by the ANTS.

Generally, the registration period for paging is greater than the registration period for a dynamic broadcast. However, the registration period for paging does not necessarily need to be greater than the registration period for a dynamic broadcast.

Moreover, when sending a BCMCS registration message, an AT sends information about the intensity of a pilot signal received by the AT from an ANTS and information (for example, pilot pseudo-noise (PN) information) about the ANTS sending the pilot signal together. The BCMCS registration message is a radio environment report (RER) message used in a link access control (LAC) layer in a CDMA2000 1× system and uses a RouteUpdate message in a CDMA2000 HRPD system. The BCMCS registration message comprises a field indicating an ANTS capable of performing soft combining. However, since the conventional system can soft combine only information received from ANTSs in the same broadcast group, information received from ANTSs of a different broadcast group is ignored.

The broadcast overhead message sent from an ANTS basically comprises information about a BCMCS flow identifier, a broadcast physical channel, a data rate, and a frame size, as well as the above-described fields. The ANTS comprises information about a cell or sector for sending the overhead message and information used for a BCMCS service in a neighbor cell or sector.

Information included in the broadcast overhead message in accordance with embodiments of the present invention will now be described in greater detail. The broadcast overhead message preferably must include the following information for each BCMCS flow in each cell or sector:

(a) Information Indicating an Activation/Inactivation State of a BCMCS Flow

An ANTS can give notification of the inactivation state of an associated BCMCS service without describing a physical channel slot in which a specific BCMCS service described in the broadcast overhead message is provided. If at least one physical channel slot for the BCMCS service is allocated, the ANTS can determine that the specific BCMCS service is active. If the information indicates the activation state, it denotes that BCMCS traffic transmission in an associated cell is in progress. The information can indicate a state in which an AT can receive the BCMCS service even though the AT does not send a BCMCS registration message. However, if the information indicates the inactivation state, it corresponds to a case opposite to the above-described activation state.

(b) Information Indicating if Soft Combining is Possible for a BCMCS Service

This information indicates if the soft combining is possible or not for the BCMCS. According to the conventional systems, the soft combining for a BCMCS service can be performed on the basis of a broadcast group. Although a pilot signal received from a different broadcast group is better when the different broadcast group provides the same BCMCS service as an associated broadcast group, broadcast traffic associated with the signal cannot be used in the soft combining as described above in Description of the Related Art section. In embodiments of the present invention as compared with the conventional systems, a broadcast group is preferably not distinguished by an ANC or PCF entity. A case where the soft combining is impossible for the same BCMCS service may occur. For example, this corresponds to a case where PDSNs are different. Generally, when the different PDSNs are used, two signals cannot be soft combined in any case. When the different PDSNs are used, it is impossible to perform the soft combining for the BCMCS service. However, because this case seldom occurs, it is negligible.

(c) Information About a Registration Required Indicator for a Dynamic Broadcast

The registration required indicator for a dynamic broadcast is a value transferred when a BCMCS service is deactivated in accordance with embodiments of the present invention. This information is a conventionally used value. A comparison between conventional systems and embodiments of the present invention will now be given.

The information comprises one field in conventional systems. When the field is set to “1”, it allows an AT to send the BCMCS registration message within a broadcast period for the dynamic broadcast. In the conventional systems, only one field is required since ANTSs of all broadcast groups provide the same BCMCS service using one BCMCS registration message.

The broadcast groups are preferably not distinguished in embodiments of the present invention. Since a cell or ANTS desiring to stop a BCMCS service and cells or ANTSs neighboring thereto must identify the message, the message preferably must further comprise fields corresponding to the number of neighbor cells or ANTSs.

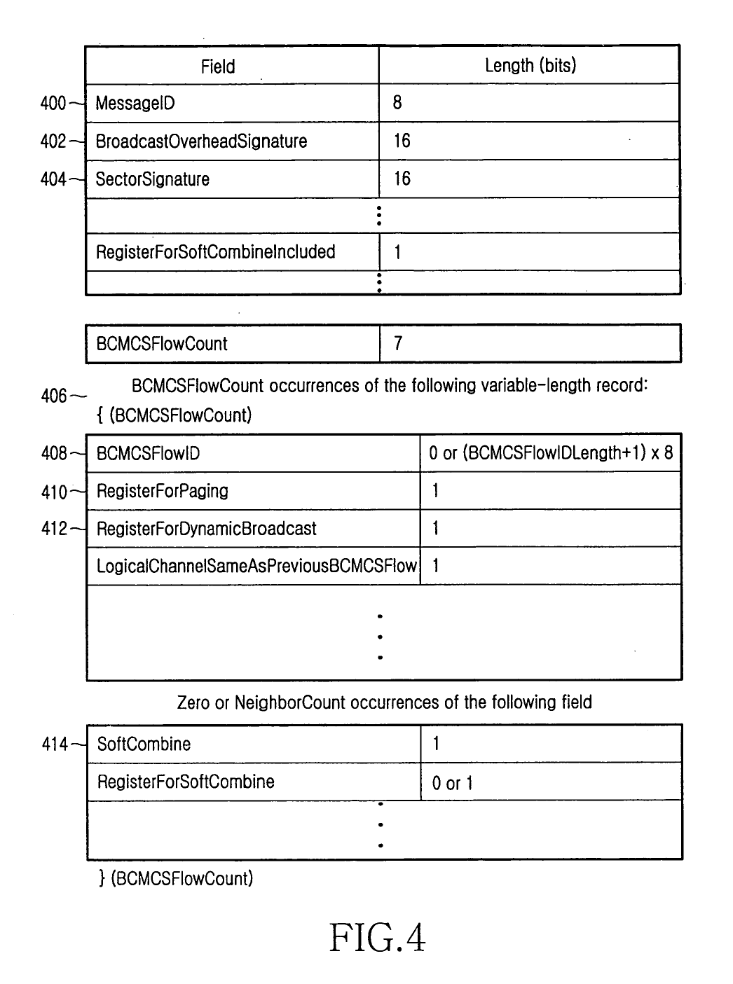

The format of a broadcast overhead message will now be described with reference to FIG. 4. FIG. 4 is a table illustrating an example of a broadcast overhead message used in embodiments of the present invention and fields which are added or modified on the basis of the conventional broadcast overhead message used for the HRPD BCMCS system.

In FIG. 4, an 8-bit MessageID field 400 indicates a message type. A 16-bit BroadcastOverheadSignature field 402 is an identifier used to distinguish the current overhead message from a previous overhead message. A 16-bit SectorSignature field 404 indicates a sector. These fields are typical fields of the overhead message used for the HRPD BCMCS system. Because other fields subsequent to the SectorSignature field are not directly associated with embodiments of the present invention, their description will be omitted.

The phrase “BCMCSFlowCount occurrences of the following variable-length record” at 406 denotes that the fields are repeated a number of times corresponding to the number of BCMCS flows. A BCMCSFlowID field 408 indicates a BCMCS service identifier (ID). A RegisterForPaging field 410 indicates registration in every registration period for paging. A value 1 of the RegisterForPaging field 410 is set to request that the AT perform registration. A RegisterForDynamicBroadcast field 412 indicates a value set to request that an AT perform aperiodic registration in every dynamic period for BCMCS service deactivation. A SoftCombine field 414 indicates if associated BCMCS data sent from a neighbor ANTS can be soft combined with associated BCMCS data sent from a serving ANTS. The message comprises SoftCombine fields corresponding to the number of neighbor ANTSs. The above-described values are conventionally used values, and the above-described typical fields have been described to assist in the understanding of embodiments of the present invention.

Fields of the overhead message in accordance with embodiments of the present invention will now be described. In FIG. 4, a RegisterForSoftCombineIncluded field (not shown) indicates if the message includes information indicating if broadcast registration is required for soft combining with a neighbor ANTS. When the RegisterForSoftCombineIncluded field is set to “1”, a RegisterForSoftCombine field (not shown) is included in the message.

The RegisterForSoftCombine field indicates if broadcast registration is required for soft combining with a specific neighbor ANTS for a specific BCMCS service. RegisterForSoftCombine fields corresponding to the number of neighbor ANTSs for one BCMCS service are included and sent in the message.

For example, the ANTS can send the following state information of Table 1 using the SoftCombine and RegisterForSoftCombine fields for a specific BCMCS service.

TABLE 1

| | RegisterFor- | |
|---|---|---|
| SoftCombine | SoftCombine | Meaning |
| 0 | 0 | An associated BCMCS service is not |
| | | sent from a neighbor ANTS, or soft |
| | | combining is disabled. |
| 0 | 1 | An associated BCMCS service is not |
| | | sent from a neighbor ANTS, or a |
| | | BCMCS service can be provided for |
| | | which soft combining is enabled |
| | | through a registration message of an AT. |
| 1 | 0 | A neighbor ANTS is currently providing |
| | | an associated BCMCS service. |
| 1 | 1 | A neighbor ANTS is currently providing |
| | | an associated BCMCS service, but the |
| | | BCMCS service will be deactivated |
| | | when a registration message is absent. |

Operation 4—Control Operation in the Network

In the network, the control operation is performed by the ANC or PCF entity. For convenience of explanation, it is assumed for purposes of the current explanation that the ANC performs the control operation in the network. A structure may be designed such that the following control operation is performed in the PCF entity. The following control operation may be subdivided such that it is partially performed in the ANC and PCF entity.

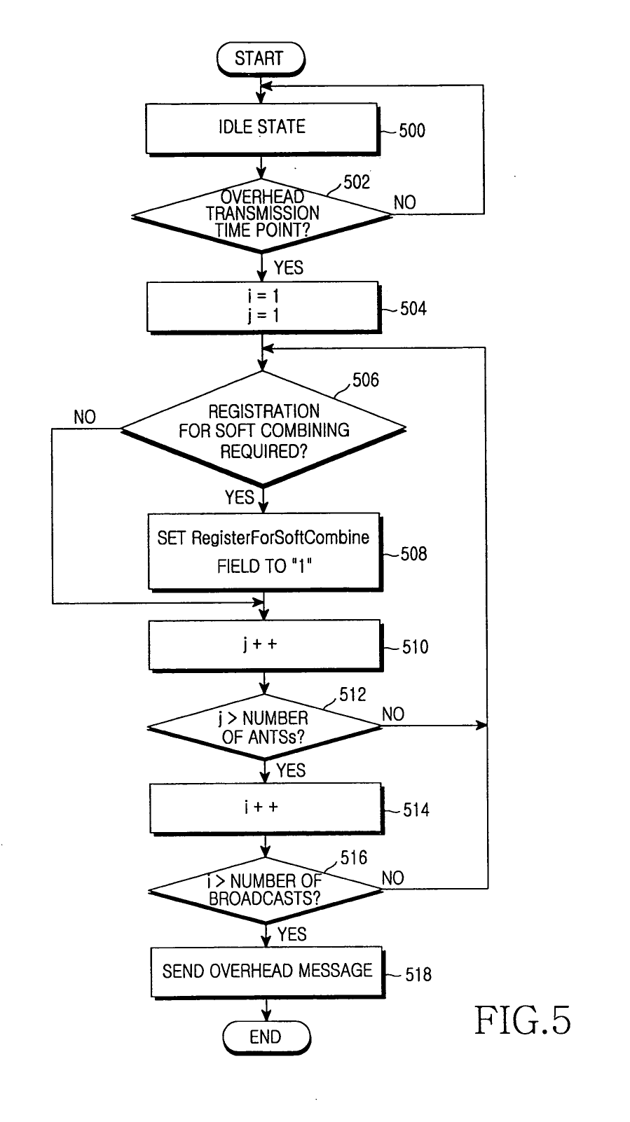

FIG. 5 is a flowchart illustrating a control operation for transmitting a broadcast overhead message while a network for providing a BCMCS service is operating in accordance with an embodiment of the present invention. The flowchart of FIG. 5 illustrates only a control flow operation based on request information for soft combining proposed in embodiments of the present invention among content of a broadcast overhead message. In the following description, it is assumed for purposes of the current explanation that the control flow process of FIG. 5 is performed in the ANC.

First, the ANC performs steps 500 to 518 of FIG. 5 in each transmission slot to set content of a broadcast overhead message at a transmission time point.

The ANC maintains an idle state in step 500 and then determines if an overhead transmission time point is reached in step 502. If the overhead message transmission time point, that is, a transmission slot time point, is reached, the ANC proceeds to step 504. Otherwise, the ANC continuously maintains the idle state.

When the overhead message transmission time point is reached, the ANC proceeds to step 504 to set the Index of Broadcast Currently Being Transmitted i=1 and the Neighbor ANTS Index j=1. Then, the ANC proceeds to step 506 to determine if registration for soft combining with a neighbor ANTS is required for Broadcast i. If the registration for soft combining is required as a result of the determination in step 506, the ANC proceeds to step 508 to set the RegisterForSoftCombine field for the Neighbor ANTS j to “1” and indicate that the registration for soft combining is required. Then, the ANC proceeds to step 510 to increment the Neighbor ANTS Index j by one. However, if registration for soft combining is not required as a result of the determination in step 506, the ANC proceeds to step 510 to increment the Neighbor ANTS Index j by one.

Then, when proceeding from step 510 to step 512, the ANC determines if the Neighbor ANTS Index j exceeds the total number of neighbor ANTSs. If the Neighbor ANTS Index j exceeds the total number of neighbor ANTSs, that is, if it is determined that registration for soft combining is required with respect to all of the Neighbor ANTSs j for the Broadcast i, the ANC proceeds to step 514. In step 514, the ANC determines if the Broadcast Index i exceeds the total number of broadcasts. If the Broadcast Index i is less than or equal to the total number of broadcasts, the ANC proceeds to step 506. However, if the Broadcast Index i exceeds the total number of broadcasts in step 516, the ANC sends an overhead message in step 518.

While performing steps 506 to 516, the ANC determines if registration for soft combining is required with respect to an ANTS to which the overhead message is sent and all the ANTSs j neighboring thereto for all the Broadcasts i currently being provided. If the registration for soft combining is required, the RegisterForSoftCombine field is set to “1” for a neighbor ANTS for an associated broadcast, such that a registration request for soft combining is set. Then, the ANC includes other information in the broadcast overhead message and sends the broadcast overhead message to the ANTSs.

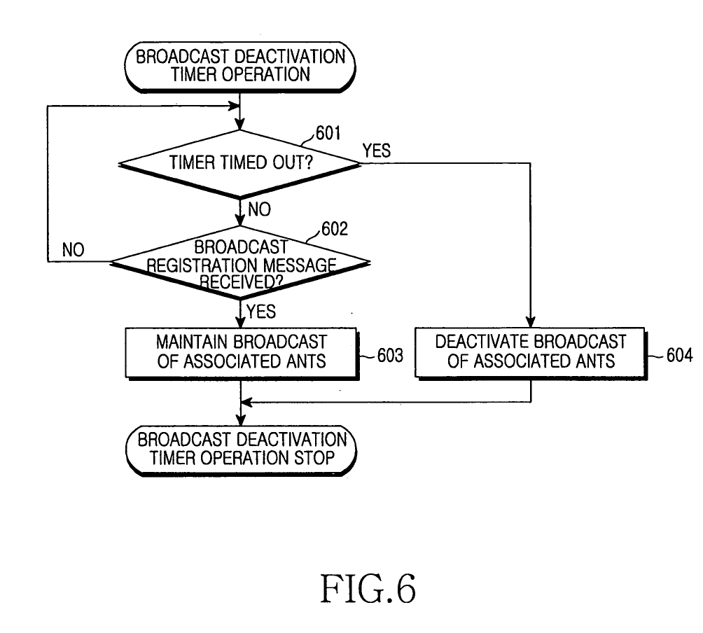

The reason for setting the registration request for soft combining in step 508 is that the associated broadcast is not provided from a neighbor ANTS when the registration request is not made. The neighbor ANTS making the registration request for soft combining performs a broadcast deactivation operation of FIG. 6, described in greater detail below. When initially making the registration request for soft combining, the neighbor ANTS sets a value of a broadcast deactivation timer for an associated broadcast and operates a timer. After the timer operates, the neighbor ANTS performs the operation of FIG. 6 in each slot.

The broadcast deactivation operation of the neighbor ANTS will now be described in greater detail with reference to FIG. 6.

The neighbor ANTS determines if the set timer has timed out in the current slot in step 601. If the value of the broadcast deactivation timer has expired, the neighbor ANTS proceeds to step 604 to deactivate the transmission of an associated broadcast.

However, if the value of the broadcast deactivation timer has not expired in step 601, the neighbor ANTS proceeds to step 602 to determine if a broadcast registration message for an associated broadcast has been received from an AT located within an area covered by an ANTS or the neighbor ANTS in the current slot. If the broadcast registration message has been received, a broadcast of the ANTS is maintained in step 603 and the operation of the broadcast deactivation timer is stopped. However, if the broadcast registration message has not been received in step 602, the neighbor ANTS returns to step 601.

AT Operation

Now, an exemplary operation of an AT will be described in greater detail. In the following description, the operation of the AT is subdivided into three operations. The three operations comprise a first operation for sending a registration message of the AT, a second operation for soft combining in the AT, and a third operation for control in the AT. The three operations will now be described.

Operation 1—Registration Message Transmission of the AT

To charge service fees to the AT in a predetermined time unit, the system for providing a BCMCS service requests that the AT periodically send a BCMCS registration message. Accordingly, the AT sends the BCMCS registration message to the ANTS in a predetermined period. In accordance with embodiments of the present invention, the AT can aperiodically send the BCMCS registration message to the ANTS. When the BCMCS registration message is sent, the AT includes neighbor cell information included in a candidate set, for example, information about the strength of a received pilot signal and so on, in the BCMCS registration message and sends the message.

When a registration timer within the AT reaches each registration time point, the BCMCS registration message is sent. For every slot, a value of the registration timer is incremented by the duration of time corresponding to a slot. That is, whenever a value of the registration timer reaches a time point for periodic broadcast registration in the case of the periodic BCMCS registration, the BCMCS registration message is sent. Whenever a value of the registration timer has reached a set time point in the case of registration for an aperiodic or dynamic broadcast or in the case of registration for soft combining, the BCMCS registration message is sent. Whenever a value of the registration timer has reached a set time point in the case of registration for soft combining, the BCMCS registration message is sent. For example, if a period of the periodic broadcast registration is 10 seconds, the AT performs periodic broadcast registration whenever a value of the registration timer is a multiple of 10 seconds. In another example, if the ANTS sends a broadcast overhead message indicating that registration for a dynamic broadcast is required and a registration period of a dynamic broadcast in an associated AT receiving the message is 3 seconds, the AT preferably must perform the registration for a dynamic broadcast whenever a value of the registration timer is a multiple of 3 seconds. This registration for a dynamic broadcast occurs only when the ANTS indicates that the registration for a dynamic broadcast is required, and is classified as the aperiodic registration which is different from the periodic registration.

As described above, the broadcast registration time points such as the periodic broadcast registration time point, the dynamic broadcast registration time point, and the broadcast registration time point for soft combining are computed on a registration period preset between the AT and ANTS, a periodic broadcast registration period, a dynamic broadcast registration period, and a broadcast registration period for soft combining. That is, each broadcast registration time point has a value of (2^{BroadcastRegistrationPeriod})×80 ms.

When multiple ATs belonging to an area covered by one ANTS send BCMCS registration messages at almost the same time, a transmission error may occur. When the error occurs, the ATs must re-transmit the BCMCS registration message many times.

To address a problem occurring when the multiple ATs simultaneously send the BCMCS registration messages to the same ANTS, the AT is provided with a registration timer in accordance with embodiments of the present invention.

When each of the ATs initially starts the BCMCS service, an initial value of the registration timer is set to an arbitrary value between zero and the maximum value of a periodic registration time point, a dynamic registration time point, and a soft combining registration time point. That is, different registration timer values are set between the ATs and therefore, transmission time points are distributed. Each AT resets the registration timer value to zero whenever the registration timer value reaches the maximum value of the periodic registration time point, the dynamic registration time point, and the soft combining registration time point.

In accordance with embodiments of the present invention, the AT monitors neighbor cell or sector information included in a broadcast overhead message received from the ANTS to send an aperiodic BCMCS registration message for soft combining. Moreover, the AT monitors the strength of a pilot signal received from a neighbor cell or sector. Then, the AT performs a BCMCS registration process according to a result of the monitoring, thereby efficiently receiving the BCMCS service.

The aperiodic broadcast registration operation to be performed in the AT according to specific fields and values of an overhead message received from the ANTS will now be described.

(1) Information Indicating an Activation/Inactivation State of a BCMCS Flow

If physical channel allocation information for a specific broadcast described in a broadcast overhead message indicates the activation state, it denotes that associated BCMCS service traffic is currently being transmitted in an associated cell. This state is a state in which the AT can receive a BCMCS service even when the BCMCS registration message is not sent. In the case of the inactivation state in which no physical channel is allocated for a specific broadcast described in the broadcast overhead message, the AT sends a BCMCS registration message and requests physical channel allocation for an associated broadcast.

(2) Registration Request Information (RegisterForSoftCombine) for Soft Combining of an Associated BCMCS Service

As illustrated in FIG. 3, the AT can receive the BCMCS service from multiple ANTSs without receiving the BCMCS service from only one ANTS. Accordingly, when the AT can receive the BCMCS service from an ANTS covering an area in which the AT is located and neighbor ANTSs, it determines if an associated ANTS (or a cell or sector) is currently providing the BCMCS service, if soft combining with neighbor ANTSs is possible, and if broadcast registration for soft combining with the neighbor ANTSs is required. An operation based on a result of the determination is then performed.

When determining that BCMCS registration for soft combining with neighbor ANTSs is required for a broadcast currently being received from the ANTS, the AT sends an aperiodic broadcast registration message to the ANTS to which the AT currently belongs to receive an associated broadcast from a neighbor ANTS. If the AT determines that the BCMCS registration is required, it denotes that registration request information for soft combining with a specific neighbor ANTS for an associated broadcast is set to “1” and that the associated neighbor ANTS belongs to a candidate set of the AT.

The registration procedure for the soft combining preferably must be performed for the specific number of ANTSs in which sufficient reception performance can be predicted to reduce downlink resource consumption and improve broadcast reception performance of the AT. To achieve this, embodiments of the present invention determine that reception performance is sufficient when a neighbor ANTS belongs to a candidate set of an associated AT and then perform the registration procedure.

Whenever the candidate set is changed as a new neighbor ANTS is added to the candidate set of the AT or as a previous neighbor ANTS is removed from the candidate set, or whenever information included in the AT is changed as a new broadcast overhead message is received, it is determined whether the registration procedure for soft combining is required.

When determining that the transmission of a registration message for soft combining with a neighbor ANTS is required, the AT sends the registration message if the registration timer reaches a registration time point (SoftCombineRegistrationTimeMax) for soft combining. To achieve this, the AT sets a registration time point for soft combining to a value corresponding to a soft combine registration period when it is determined that the registration procedure for soft combining is required and that the registration for soft combining is inactive. In this case, when the registration for soft combining is inactive, a value of SoftCombineRegistrationTimeMax is zero.

However, different ATs within the cell can first send a registration message for soft combining with a neighbor ANTS in the registration for soft combining that is different from the periodic broadcast registration. When the reception performance of an associated neighbor ANTS is lowered to a value that is incapable of ensuring sufficient reception performance before a timer reaches a registration time point, the associated neighbor ANTS can be excluded from the candidate set. When this state occurs, an associated AT preferably must not send a registration message for soft combining. To achieve this, the registration time point for soft combining is set to zero and therefore, the registration for soft combining must be inactivated.

(3) Registration Required Indicator for a Dynamic Broadcast

An indicator field is conventionally used as described above in relation to the network. When the field is set to “1”, an AT sends a broadcast registration message in a broadcast period for a dynamic broadcast.

Operation 2—Soft Combining of the AT

A process in which the AT soft combines broadcast traffic sent from a cell in which the AT is located and a neighbor cell is substantially the same as the conventional process. The AT soft combines only broadcast traffic sent from the serving cell and broadcast traffic sent from a cell for which soft combining is possible among cells sending broadcast traffic desired by a user. That is, the soft combining is enabled through the broadcast overhead message, and traffic of a cell sending an associated broadcast is soft combined.

Operation 3—Control Operation of the AT

A control process to be performed in the AT for receiving a BCMCS service in accordance with embodiments of the present invention will now be described.

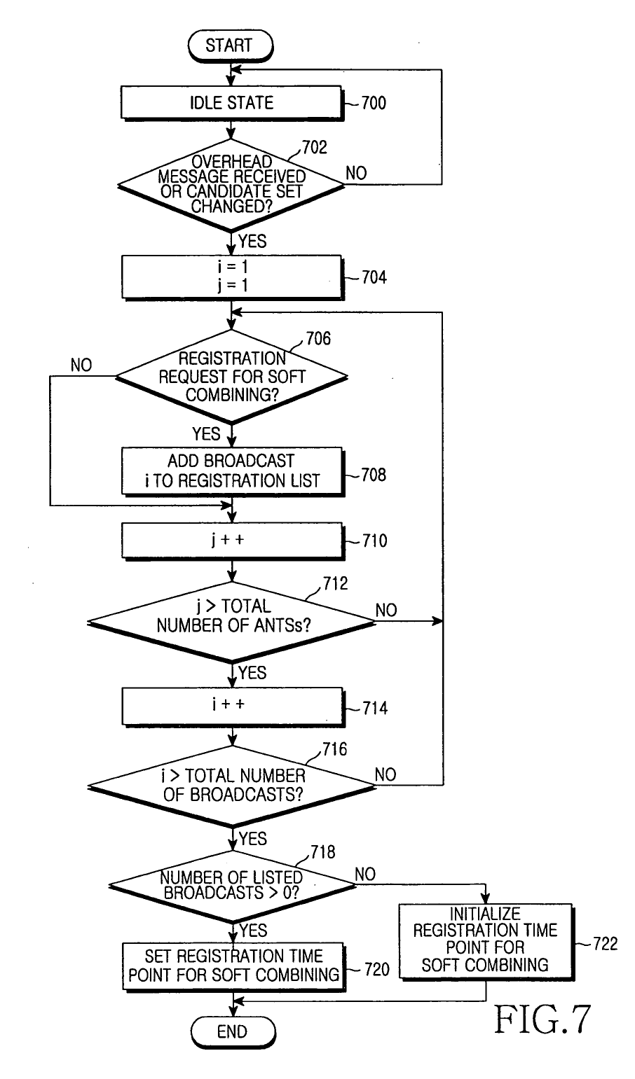

FIG. 7 illustrates an operation for determining if broadcast registration for soft combining is required in the AT in accordance with an embodiment of the present invention. The AT preferably must determine if broadcast registration for soft combining is required through the operation of FIG. 7 in each slot.

First, the AT maintains an idle state in step 700. The AT receives an overhead message or determines if a candidate set has been changed in step 702. Because new broadcast registration is not required for soft combining if the overhead message has not been received or the candidate set has not been changed, the AT proceeds to step 700 to maintain the idle state.

When it is determined that the overhead message has been received or that the candidate set has been changed in step 702, the AT proceeds to step 704. In step 704, the AT sets the Received Broadcast Index i=1 and sets the ANTS Index j=1, where the ANTS Index j denotes an ANTS belonging to the candidate set. Then, the AT determines if ANTS j belonging to the candidate set for the Received Broadcast i has requested the soft combining in step 706. If ANTS j belonging to the candidate set for the Received Broadcast i has requested the soft combining, the RegisterForSoftCombine field of ANTS j for Broadcast i is set to “1” in the most recently received broadcast overhead message.

If it is determined that ANTS j belonging to the candidate set for the Received Broadcast i has requested the soft combining in step 706, the AT proceeds to step 708 to add Broadcast i to a registration list for soft combining and then proceeds to step 710 to increment the ANTS Index j by one. However, if it is determined that ANTS j belonging to the candidate set for the Received Broadcast i has not requested the soft combining in step 706, the AT proceeds to step 710 to increment the ANTS Index j by one.

Then, when proceeding from step 710 to step 712, the AT determines whether the ANTS Index j exceeds the total number of ANTSs belonging to the candidate set. If the ANTS Index j is less than or equal to the total number of ANTSs belonging to the candidate set, the AT proceeds to step 706 to determine if the registration request for soft combining for the Broadcast i has been received from the next ANTS j.

However, if the ANTS Index j exceeds the total number of ANTSs belonging to the candidate set in step 712, the AT proceeds to step 714 to increment the Broadcast Index i by one. Then, the AT proceeds to step 716 to determine whether the Broadcast Index i exceeds the total number of broadcasts received by the AT. If the Broadcast Index i is less than or equal to the total number of broadcasts received by the AT, the AT proceeds to step 706. However, if the Broadcast Index i exceeds the total number of broadcasts received by the AT, the AT proceeds to step 718.

While performing steps 706 to 716, the AT determines whether all of the ANTSs j belonging to the candidate set have made requests for soft combining for all of the Broadcasts i to be received by the AT, and then generates a registration list for soft combining including all of the Broadcasts i necessary for soft combining.

If the number of broadcasts necessary for registration for soft combining is at least one in the registration list for soft combining when the AT proceeds from step 716 to step 718, the AT proceeds to step 720 to set the registration for soft combining. Here, the registration process sets a value of a preset time point to (2^{SoftCombinePeriod})×80 ms

However, if a broadcast necessary for registration for soft combining is absent in the registration list for soft combining in step 718, the registration time point for soft combining is initialized to zero, such that registration for soft combining does not occur.

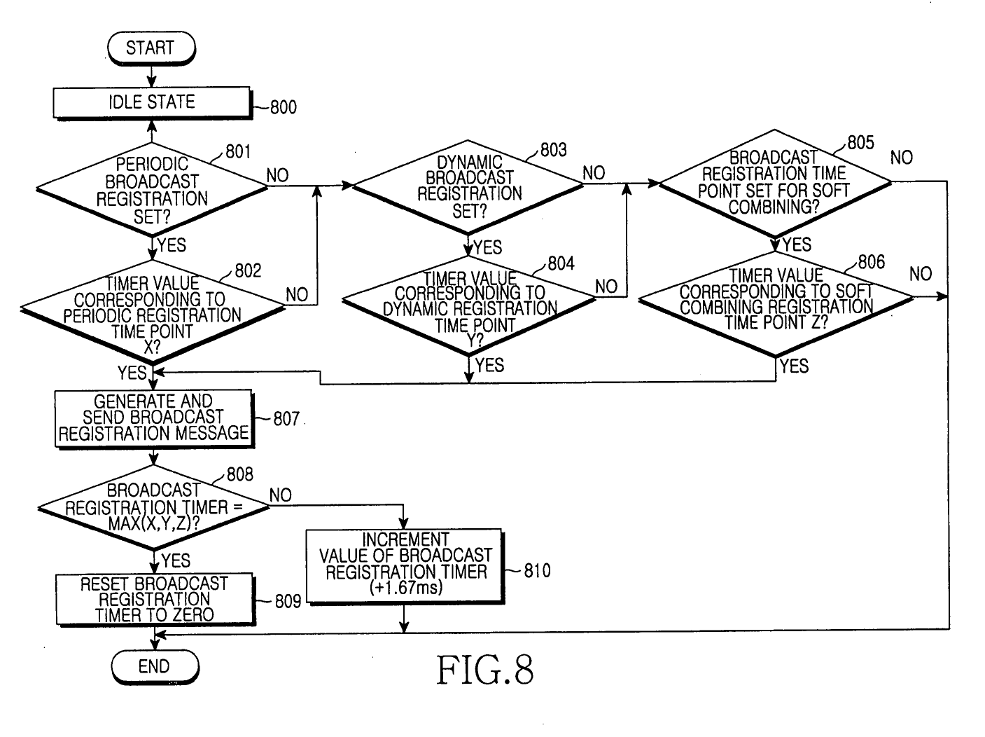

As described above, the AT determines if the periodic broadcast registration, the dynamic broadcast registration or the broadcast registration for soft combining is required in each slot using the operation of FIG. 8.

Through this determination as to whether the broadcast registration is required, a broadcast registration timer provided in the AT is started and a broadcast registration message is generated and sent when each broadcast registration time point is reached. For this, the AT can compute an initial value of the broadcast registration timer as shown in Equation (1) when the ANTS indicates that the registration for a BCMCS service is required.
Timer Initial Value=0˜Max(2^{PeriodicBroadcastRegistrationPeriod},2^{DynamicBroadcastRegistrationPeriod},2^{SoftCombineRegistrationPeriod})×80 ms Equation (1)

In Equation (1), Max denotes the maximum value selected from values within the parentheses. That is, the timer initial value is randomly set between zero and the Max value from an initial time point of each slot. For every slot, an initial value of the initialized broadcast registration timer is incremented by 1.6667 ms corresponding to the duration of time of a slot.

The operation in which the AT determines whether the periodic broadcast registration, the dynamic broadcast registration or the broadcast registration for soft combining is required in each slot, and generates and sends a broadcast registration message when each broadcast registration time point is reached, will now be described with reference to FIG. 8.

First, the AT maintains an idle state in step 800 and then determines whether the periodic broadcast registration has been set in step 801. If the periodic broadcast registration has been set, the AT proceeds to step 802 to determine whether a value of the current broadcast registration timer corresponds to a periodic broadcast registration time point (“X”=2^{PeriodicBroadcastRegistrationPeriod} * 80 ms). If the broadcast registration timer reaches the periodic broadcast registration time point, the AT proceeds to step 807 to generate and send a broadcast registration message including information about all of the broadcasts for which broadcast registration is required.

If the periodic broadcast registration has not been set in step 801 or the current broadcast registration timer has not reached the periodic registration time point in step 802, the AT determines whether the dynamic broadcast registration has been set in step 803. If the dynamic broadcast registration has been set, the AT determines if the current broadcast registration timer has reached the dynamic broadcast registration time point “Y” in step 804. If the current broadcast registration timer has reached the dynamic broadcast registration time point in step 804, the AT generates and sends the broadcast registration message including information about all of the broadcasts necessary for broadcast registration in step 807.

If the dynamic broadcast registration has not been set in step 803 or if the current broadcast registration timer has not reached the dynamic registration time point in step 804, the AT proceeds to step 805 to determine whether a broadcast time point for soft combining has been set to a non-zero value. If the broadcast registration time point for soft combining has been set, the AT proceeds to step 806 to determine whether the current broadcast registration timer has reached the broadcast registration time point “Z” for soft combining. If the current broadcast registration timer has reached the broadcast registration time point for soft combining in step 806, the AT generates and sends the broadcast registration message including information about all of the broadcasts necessary for broadcast registration in step 807.

However, if the broadcast registration for soft combining has not been set in step 805, or if the current broadcast registration timer has not reached the registration time point for soft combining in step 806, the AT stops a broadcast registration operation in an associated slot.

After sending the broadcast registration message in step 807, the AT resets the broadcast registration timer to zero in step 809 to prevent the timer from being triggered when the current broadcast registration timer has reached the periodic broadcast registration time point, the dynamic broadcast registration time point or the broadcast registration time point for soft combining in step 808. If the broadcast registration time point does not correspond to the maximum value, the AT increments a value of the broadcast registration timer by 1.667 ms corresponding to the slot length in step 810 and stops the broadcast registration operation in an associated slot.

As is apparent from the above description, embodiments of the present invention can receive a broadcast/multicast service (BCMCS) from associated access network transceiver systems (ANTSs) by giving notification of information about the ANTSs for which a soft combining operation can be performed in an access terminal (AT) and can prevent radio resources from being wasted. Moreover, embodiments of the present invention can prevent a broadcast service registration message from being re-transmitted due to a transmission error occurring when ATs simultaneously transmit broadcast service registration messages to the same ANTS because a registration timer is provided in each AT.

Although exemplary embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

What is claimed is:

1. A method for providing a broadcast/multicast service (BCMCS) service from an access network transceiver system (ANTS) to an access terminal (AT) in a mobile communication system configured by ANTSs and ATs, comprising the steps of:
starting a broadcast deactivation timer for an associated BCMCS service when a registration request for soft combining is set and determining when the started broadcast deactivation timer has timed out;
deactivating transmission for the BCMCS service when the broadcast deactivation timer has timed out and stopping an operation of the broadcast deactivation timer; and
determining if a broadcast registration message for the BCMCS service has been received when the broadcast deactivation timer has not timed out, maintaining the BCMCS service when the broadcast registration message has been received for the BCMCS service, and stopping the operation of the broadcast deactivation timer.

2. The method of claim 1, wherein the BCMCS service is soft combined with a BCMCS service of a neighbor ANTS.

3. The method of claim 1, wherein the step of determining if the broadcast deactivation timer has timed out is performed for every slot.

4. The method of claim 1, further comprising the step of:
providing the registration request for the soft combining to an AT through a broadcast overhead message of a neighbor ANTS such that the AT sends the broadcast registration message when the AT requiring the BCMCS service transmission of the ANTS is located at the neighbor ANTS for the soft combining.

5. The method of claim 4, wherein the broadcast overhead message comprises registration requests for the soft combining corresponding to the number of BCMCS services, the registration requests being distinguished by BCMCS flow identifiers (IDs).

6. The method of claim 1, wherein the broadcast registration message for the associated BCMCS service is received from an AT included in an area of an ANTS or from an AT included in an area of a neighbor ANTS.

7. The method of claim 6, wherein the broadcast registration message from the AT included in the area of the neighbor ANTS is received through the neighbor ANTS.

8. A method for requesting that a neighbor access network transceiver system (ANTS) provide a broadcast/multicast service (BCMCS) service for which soft combining is enabled in an access terminal (AT) receiving the BCMCS service provided from an ANTS, comprising the steps of:
determining if a registration request for the soft combining from an ANTS belonging to a candidate set is present; and
setting a soft combining broadcast registration time point to send a broadcast registration message including a BCMCS service provision request for the soft combining.

9. The method of claim 8, further comprising the step of:
sending the broadcast registration message when a broadcast registration timer reaches the soft combining broadcast registration time point.

10. The method of claim 9, wherein an initial value of the broadcast registration timer is set to an arbitrary value.

11. The method of claim 8, further comprising the step of:
adding the ANTS to a registration list for the soft combining when the registration request for the soft combining is present.

12. The method of claim 8, wherein the step of determining if the registration request is present is performed when an overhead message is received.

13. The method of claim 12, wherein the step of determining if the registration request is present is performed when the candidate set is changed.

14. The method of claim 8, wherein the candidate set is determined by an intensity of a pilot signal.

15. The method of claim 12, further comprising the step of:
when at least one ANTS is included in a registration list for the soft combining, setting the soft combining broadcast registration time point according to a soft combining broadcast registration period received from the at least one ANTS.

16. The method of claim 8, wherein when no ANTS is present in a registration list for the soft combining, the soft combining broadcast registration time point is disabled and soft combining broadcast registration is not performed.

17. The method of claim 8, wherein the broadcast registration message comprises a message requesting broadcast transmission for the soft combining, the message being sent to ANTSs included in a registration list for the soft combining.

18. A method for sending a broadcast/multicast service (BCMCS) service provision request from an access terminal (AT) to an access network transceiver system (ANTS) in a communication system configured by ANTSs and ATs, the AT receiving a BCMCS service from the ANTS, the method comprising the steps of:
setting a transmission time point of a broadcast registration message using a broadcast registration timer; and
sending the broadcast registration message to the ANTS when the transmission time point of the broadcast registration message is reached.

19. The method of claim 18, wherein the transmission time point comprises at least one of a time point when the broadcast registration timer has reached a periodic registration time point, a dynamic registration time point and a soft combining registration time point.

20. The method of claim 19, wherein an initial value of the broadcast registration timer is set to an arbitrary value.

21. The method of claim 20, wherein the initial value of the broadcast registration timer is set to an arbitrary value between zero and a maximum value of the periodic registration time point, the dynamic registration time point and the soft combining registration time point.

22. The method of claim 19, wherein the broadcast registration timer is reset when reaching a maximum value of the periodic registration time point, the dynamic registration time point, and the soft combining registration time point.

23. A system for providing a broadcast/multicast service (BCMCS) service, comprising:
an access terminal (AT) for determining whether a registration request for soft combining from an access network transceiver system (ANTS) belonging to a candidate set is present when an overhead message is received from the ANTS or when the candidate set is changed, adding the ANTS to a registration list for the soft combining when the request is present, and sending to the ANTS a broadcast registration message at a transmission time point after setting the transmission time point to send the broadcast registration message including a BCMCS service provision request for the soft combining; and
a network for providing the AT with the overhead message comprising information about neighbor ANTSs and information about ANTSs for which the soft combining on broadcast traffic is enabled.
